(19) United States
(12) Patent Application Publication
(10) Pub. No.: US 2011/0249941 A1
(43) Pub. Date: Oct. 13, 2011

(54) TELECOMMUNICATION SOCKET OUTLET

(75) Inventors: Brent David Allwood, New South Wales (AU); Brett Hoe Slater, New South Wales (AU); Wayne William Dennes, New South Wales (AU)

(73) Assignee: ADC GmbH, Berlin (DE)

(21) Appl. No.: 13/120,969

(22) PCT Filed: Sep. 4, 2009
(86) PCT No.: PCT/EP2009/006426

§ 371 Date: Jun. 16, 2011

(30) Foreign Application Priority Data
Sep. 25, 2008 (AU) 2008905001

(51) Int. Cl. G02B 6/38; H01R 43/00; G02B 6/46

(52) U.S. Cl. 385/56; 29/825

(57) ABSTRACT

A telecommunications outlet box for effecting connections between telecommunications transmission lines in a telecommunications system, including a mounting for a copper connector for effecting electric connections between a plurality of twisted pairs of insulated conductors of a first data cable and a plurality of corresponding twisted pairs of insulated conductors of a second data cable; and two mountings for two separate optical fibre connectors for effecting optic connections between optical fibres, therein the mounting for the copper connector and the mountings for the optical fibre connectors are respectively selectively couplable to copper and optical fibre connectors to configure the box for use in the telecommunications system.

### TECHNICAL FIELD OF THE INVENTION

The present invention relates to a telecommunications outlet box.

### BACKGROUND OF THE INVENTION

Cable management is extremely important in the telecommunications industry. Effective cable management prevents cables from becoming entangled and enhances signal transmission quality by ensuring that minimum bend radius requirements are maintained. It is generally desirable to protect connection regions from impact related damage and contamination.

Telecommunications outlet boxes, such as surface/wall mount boxes and free standing boxes, typically house a number of components including telecommunications connectors used to provide interconnections between telecommunication transmission lines. Different types of telecommunications connectors are frequently provided to allow the outlet boxes to be compatible with different types of transmission lines. This allows a single outlet box to be used to configure a work station area with various types of transmission lines for different applications.

An optical fiber connector terminates an end of an optical fiber, and enables quicker connection and disconnection than splicing. The connectors mechanically couple and align the cores of fibers so that light can pass therethrough. A variety of optical fiber connectors are available. The main differences among types of connectors are dimensions and methods of mechanical coupling. Some examples of typical telecommunications connectors are:
a. Copper connectors, such as modular jacks;
b. BNC coax adapters;
c. F-type adapters;
e. RCA adapters or connectors;
f. SC fibre adapters; and
g. ST fibre adapters.

In a typical office, for example, a telecommunications outlet box may be used as an interface through which electric devices, such as computers, can be coupled to electric communications networks. The outlet box may be used to couple a computer to a copper/twisted pair telecommunications network. Alternatively, the outlet box may be used to couple the computer to an optic fibre network. In these examples, the outlet box may include a RJ45 connector for mating with a RJ45 plug of a telecommunications data cable coupled to the computer and an SC coupler for effecting optic connections between optical fibres.

The outlet box is typically coupled to a wall box, seated in a wall cavity. The wall box anchors the outlet box to the wall and acts as a conduit through which optic fibre and copper twisted pair pass from the wall cavity into the outlet box. A type 86 outlet box, for example, is designed for use with a type 86 wall box. The dimensions of the type 86 wall box are 86 mm by 86 mm. The functionality of known type 86 telecommunications outlet may be fixed and my not be adapted to meet the changing needs of an office, for example. Further, known outlet boxes may not be adapted to include a selection of copper and/or optic fibre connectors. It may be generally desirable to increase the functionality of a type 86 telecommunications outlet.

Known outlet boxes may not have provision to adequately manage optic fibres. The optical fibres may not, therefore, be securely located within an outlet box in a manner that prevents damage. Further, known outlet boxes may not be able to adequately house multiple fusion splices.

It is generally desirable to overcome or ameliorate one or more of the above mentioned difficulties, or at least provide a useful alternative.

### SUMMARY OF THE INVENTION

In accordance with one aspect of the present invention, there is provided a telecommunications outlet box for effecting connections between telecommunications transmission lines in a telecommunications system, including:
(a) a mounting for a copper connector for effecting electric connections between a plurality of twisted pairs of insulated conductors of a first data cable and a plurality of corresponding twisted pairs of insulated conductors of a second data cable; and
(b) two mountings for two separate optical fibre connectors for effecting optic connections between optical fibres,
   wherein the mounting for the copper connector and the mountings for the optical fibre connectors are respectively selectively couplable to copper and optical fibre connectors to configure the box for use in the telecommunications system.

Preferably, the outlet box includes a housing having a base couplable to a wall box seated in a wall cavity of a work station area, and a cover couplable to the base.

Preferably, the mounting for the copper connector and the mountings for the optical fibre connectors are arranged so that copper and optical fibre connectors coupled thereto are accessible for external connection.

Preferably, the mounting for the copper connector and the mountings for the optical fibre connectors are arranged so that copper and optical fibre connectors coupled thereto are accessible for external connection from a common side of the outlet box.

Preferably, the common side of the box is a bottom side of the box that faces a floor or ground surface when the box is coupled to the wall box.

Preferably, the mounting for the copper outlet is arranged between the mountings for the optical fibre outlets.

Preferably, the mounting for the copper connector is a keystone mounting for an RJ45 connector.

Preferably, the outlet box includes a cable management channel for receiving and retaining optical fibres.

Preferably, the wall box is a type 86 wall box.

In accordance with another aspect of the invention, there is provided a method for installing the above described outlet box, including the steps of:
(a) securing a copper connector to the copper connector mounting; and
(b) connecting the insulated conductors of the second data cable to corresponding contacts of the copper connector.

In accordance with another aspect of the invention, there is provided a method for installing the above described outlet box, including the steps of:
(a) securing a field terminable optical fibre connector to one of the optical fibre mountings; and
(b) spooling optical fibre of the field terminable optical fibre connector around a cable management channel of the outlet box in a conical manner so that the internal spool is tapered outwards as it approaches the base causing ends of the optical fibre to sit towards a bottom end of the management channel.

In accordance with another aspect of the invention, there is provided a method for installing the above described outlet box, including the steps of:
(a) securing an optical fibre connector to one of the optical fibre connector mountings;
(b) spooling a pigtail of said one of said optical fibre connectors around the generally circular cable management channel in a conical manner so that the internal spool is tapered outwards as it approaches the base causing ends of the pigtail to sit towards a bottom end of the management channel;
(c) directing an end of the pigtail into a corresponding fusion splice channel;
(d) receiving an end of an optical fibre through an access aperture in the cable management channel;
(e) spooling the end of the optical fibre, in an opposite direction to the pigtail, in a conical manner so that the internal spool is tapered outwards as it approaches the base causing ends of the optical fibre to sit towards a bottom end of the management channel;
(f) directing an end of the end of optical fibre into another end of the fusion splice channel; and
(g) fusion splicing the end of the pigtail with the end of said end of optical fibre.

In accordance with another aspect of the invention, there is provided a method for installing the above described outlet box, including the steps of:
(a) securing an optical fibre connector to one of the optical fibre connector mountings;
(b) spooling a pigtail of said one of said optical fibre connectors around the generally circular cable management channel in a conical manner so that the internal spool is tapered outwards as it approaches the base causing ends of the pigtail to sit towards a bottom end of the management channel;
(c) directing an end of the pigtail into a corresponding fusion splice channel;
(d) receiving an end of an optical fibre through a break away panel in the outlet box;
(e) spooling the end of the optical fibre, in an opposite direction to the pigtail, in a conical manner so that the internal spool is tapered outwards as it approaches the base causing ends of the optical fibre to sit towards a bottom end of the management channel;
(f) directing an end of the end of optical fibre into another end of the fusion splice channel; and
(g) fusion splicing the end of the pigtail with the end of said end of optical fibre.

Preferably, the method includes the steps of securing a copper connector to the copper connector mounting; and connecting the insulated conductors of the second data cable to corresponding contacts of the copper connector.

### BRIEF DESCRIPTION OF THE DRAWINGS

Preferred embodiments of the present invention are hereafter described, by way of non-limiting example only, with reference to the accompanying drawing in which:

FIG. 1 is a perspective view of a telecommunications outlet box;

FIG. 2 is a front view of the outlet box shown in FIG. 1;

FIG. 3 is a bottom view of the outlet box shown in FIG. 1;

FIG. 4 is back view of the outlet box shown in FIG. 1;

FIG. 5a is a front perspective view of the outlet box shown in FIG. 1 coupled to a wall box;

FIG. 5b is a back perspective view of the outlet box and the wall box shown in FIG. 5a;

FIG. 6 is a front view of a base of the outlet box shown in FIG. 1;

FIG. 7 is a front perspective view of the base of the outlet box shown in FIG. 6;

FIG. 8 is a bottom view of the outlet box shown in FIG. 6 with the breakout panels in place;

FIG. 9a is a front perspective view of the base of the outlet box shown in FIG. 6 showing a copper connector connected to a cable of insulated conductors in a first manner;

FIG. 9b is a front perspective view of the base of the outlet box shown in FIG. 6 showing a copper connector connected to a cable of insulated conductors in a second manner;

FIG. 10a is a front view of the base of the outlet box shown in FIG. 6 with the copper and optical fibre connectors removed;

FIG. 10b is a bottom view of the base of the outlet box shown in FIG. 10a;

FIG. 11 is a front perspective view of the base of the outlet box shown in FIG. 6 with an alternative copper connector;

FIG. 12 is a front view of the base of the outlet box shown in FIG. 6 with an optical fibre of an SC optical fibre connector arranged in a condition of use;

FIG. 13 is a front view of the outlet box shown in FIG. 6 with a pigtail of an SC optical fibre connector coupled to an end of another optical fibre received from an access aperture by way of a fusion splice;

FIG. 14 is a front view of the outlet box shown in FIG. 6 with a pigtail of an SC optical fibre connector coupled to an end of another optical fibre received from a breakout piece by way of a fusion splice;

FIG. 15 is a front view of the base of the outlet box shown in FIG. 6 with pigtails of an LC optical fibre connector connected to respective ends of optical fibres received from an access aperture by way of fusion splices; and

FIG. 16 is a bottom view of the base of the outlet box shown in FIG. 15.

### DETAILED DESCRIPTION OF PREFERRED EMBODIMENTS OF THE INVENTION

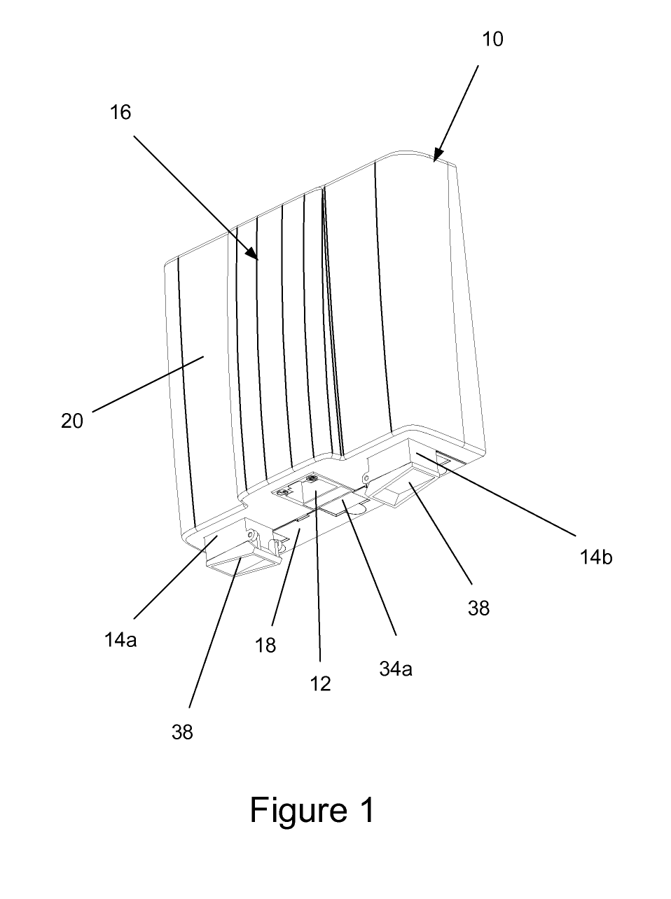

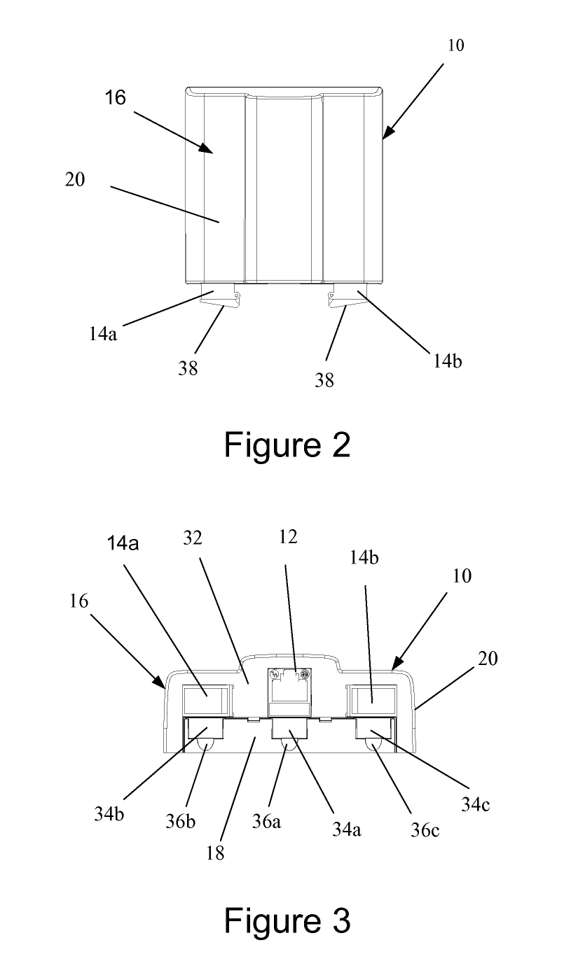

The telecommunications outlet box 10 shown in FIGS. 1 to 7 is used to effect connections between telecommunications transmission lines in a telecommunications system. The outlet box includes a mounting 47 for a copper connector 12 for effecting electric connections between a plurality of twisted pairs of insulated conductors of a first data cable (not shown) and a plurality of corresponding twisted pairs of insulated conductors of a second data cable (not shown). The outlet box also includes two mountings 57a, 57b for two separate optical fibre connectors 14a, 14b for effecting optic connections between optical fibres. The mounting 47 for the copper connector 12 and the mountings 14a, 14b for the optical fibre connectors 14a, 14b are respectively selectively couplable to copper and optical fibre connectors 12, 14a, 14b to configure the box 10 for use in the telecommunications system. The outlet box 10 facilitates independent use of the copper connector 12 and the optic fibre connectors 14a, 14b. The copper connector 12 is preferably a right angled RJ45 connector 12 and the optical fibre connectors 14a, 14b are preferably SC or LC couplers 14a, 14b. The outlet box 10 is configurable to use any suitable combination of connectors 12, 14a, 14b supported by the mountings 47, 57a, 57b.

Advantageously, the outlet box 10 facilitates good cable management, inhibits cable entanglement, and enhances signal transmission quality by ensuring that minimum bend radius requirements are maintained. The outlet box 10 includes features for management of the ends of optical fibres and the facility to secure a number of fusion splices as necessitated by the relevant telecommunications system. The outlet box 10 is preferably upgradeable. That is, where the outlet box 10 has been installed with just a copper connector 12, it can later be upgraded to include fibre connectors 14a, 14b. The copper connector 12 can then be eliminated, if required. As such, a new provider can be installed without interruption to an existing service.

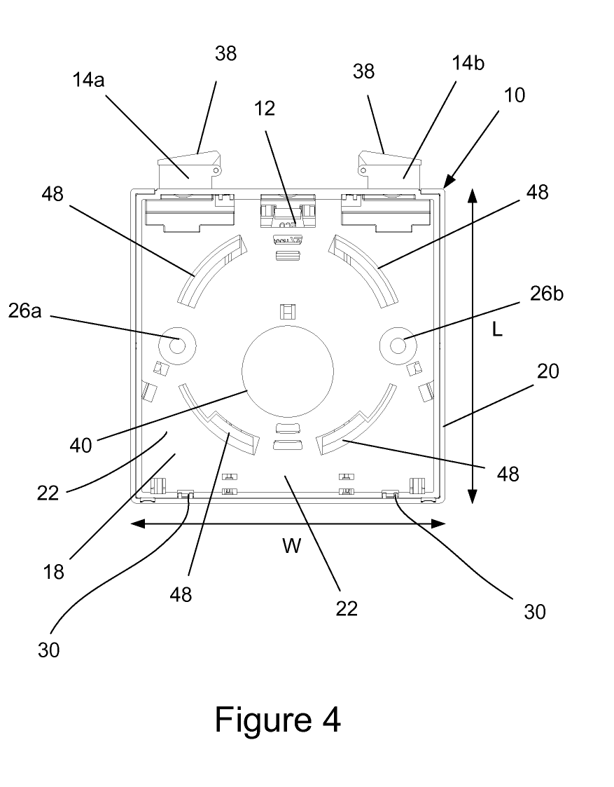

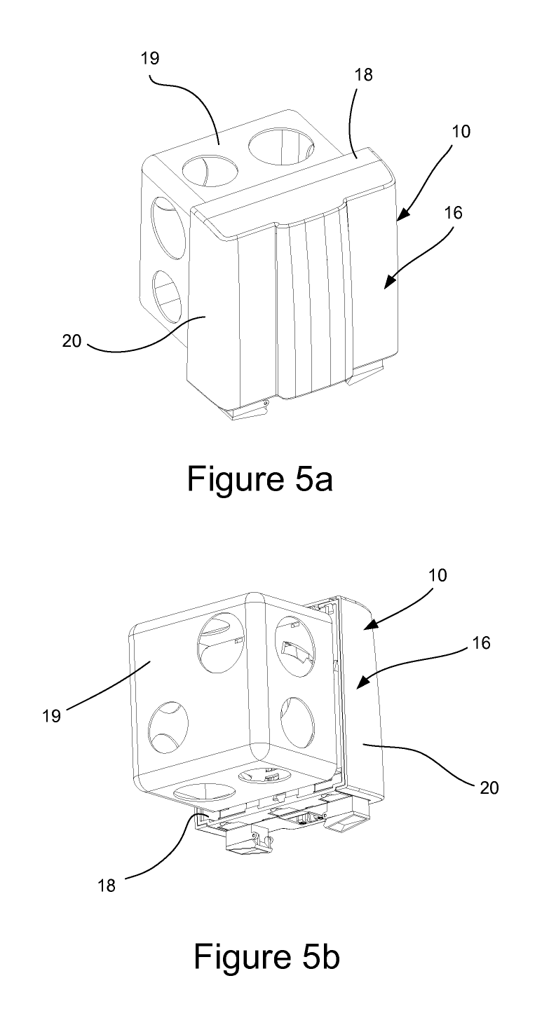

As particularly shown in FIGS. 5a and 5b, the outlet box 10 includes a housing 16 having a base 18 couplable to a wall box 19 seated in a wall cavity (not shown) of a telecommunications system in a work station area, and a cover 20 couplable to the base 18. As particularly shown in FIG. 4, the outer side 22 of the base 18 is a generally planar square plate of suitable dimensions to fit over the corresponding wall box. For example, where outlet box 10 is to be used with a Type 86 wall box, the outer side 22 of the base 18 has a length “L” of 86 mm and a width “W” of 86 mm. Thus, the base 18 is preferably suitable for use with a Type 86 wall box.

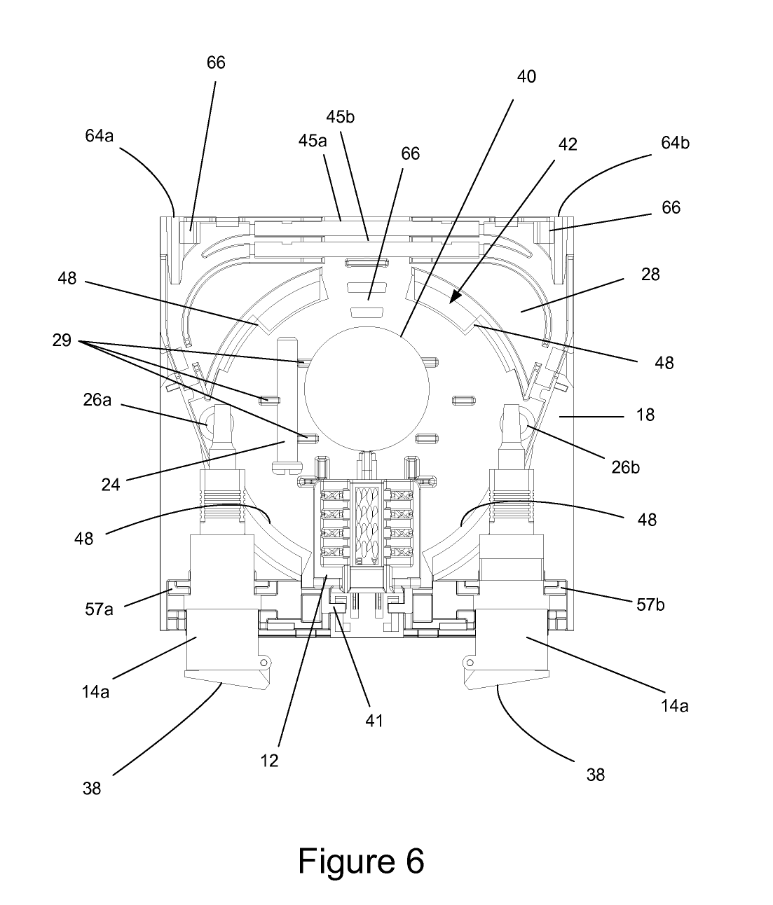

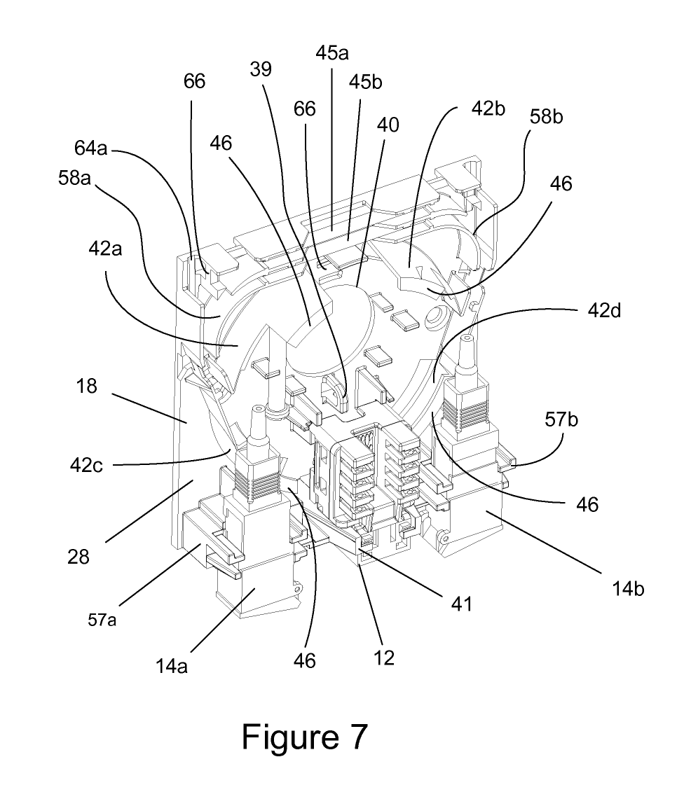

As particularly shown in FIGS. 6 and 7, the base 18 is couplable to the wall box by way of two screws 24 inserted through apertures 26a, 26b formed in the base 18. The screws 24 engage corresponding threads formed in the wall box and thereby secure the base 18 to the wall box. The screws 24 are couplable to an inner side 28 of the base 18 by way of lugs 29 in the manner shown in FIGS. 6 and 7.

As above-mentioned, the cover 20 is couplable to the base 18 and serves to protect the internal components of the box 10 from external contact. The cover 20 is preferably formed as a shell that is shaped to extend over the topography of the internal components of the box 10. As such, the cover 20 extends outwardly away from the inner side 28 of the base 18 to a sufficient extent so as not to contact the internal components of the box 10. The cover 20 preferably inhibits ingress of dust and other contaminants into the box 10. The cover 20 is couplable to the base 18 by way of corresponding male and female clips 30 formed in the base 18 and cover 20. The clips 30 are shaped to snap lock when the parts 18, 20 are arranged over one another and pushed together. The clips 30 are arranged to be opened by way of a screw driver, for example, so that the cover 20 can be separated from the base 18. Alternatively, any other suitable fastener could be used to secure the cover 20 to the base 18.

The copper connector 12 and the optical fibre connectors 14a, 14b are accessible for connection with external transmission lines from a common bottom side 32 of the box 10. The common bottom side 32 of the box 10 opposes a floor or ground surface (not shown) when the box 10 is coupled to the wall box to inhibit the ingress of contaminants into the box 10. Advantageously, the orientation of the optical fibre connectors 14a, 14b reduces the likelihood of a person being exposed to the harmful light being emitted by a connected optical fibre. That is, any emission by either the absence of a shutter 36, or the opening thereof, will be directed down the wall towards a floor or ground surface rather than outward, reducing the chance of exposure to the naked eye.

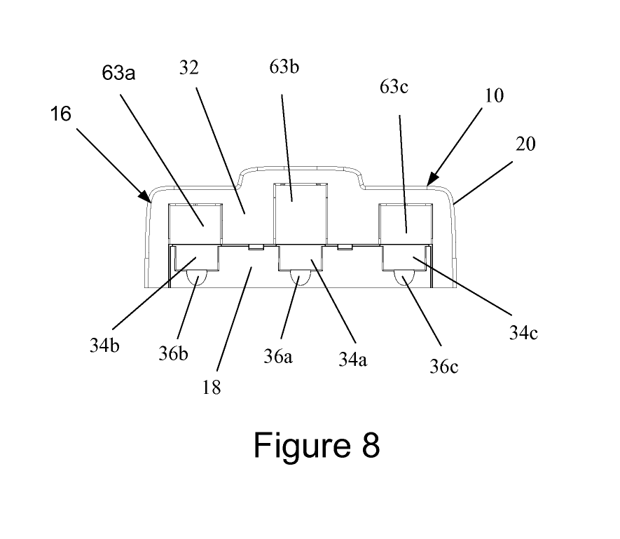

As particularly shown in FIG. 8, the telecommunications outlet box 10 includes breakout panels 63a, 63b, 63c that are readily detachable from the housing 16 to configure the box 10 for use in a particular telecommunications system. For example, where the box 10 is to be used in a copper telecommunications system only, the breakout panel 63b is removed from the housing 16, which permits the installation of the copper connector 12 on the mounting 47. The copper connector 12 is thereby accessible for external connection and the mountings 57a, 57b for optical connectors 14a, 14b remain closed behind panels 63a, 63c. The outlet box 10 can then be upgraded to include optical connectors 14a, 14b by removing the breakout panels 63a, 63b, as needed. Alternatively, where the box 10 is to be used in a optical telecommunications system only, the breakout panels 63a, 63c are removed from the housing 16, which permits the installation of the optical connectors 14a, 14b on the mountings 57a, 57b. The optical connectors 14a, 14b are thereby accessible for external connection and the mounting 47 for the copper connector 12 remains closed behind breakout panel 63b.

The common bottom side 32 of the box 10 include three labels 34a, 34b, 34c, one for each of the copper connector 10 and the two optical fibre connectors 14a, 14b. Each label 34a, 34b, 34c includes a recess covered by a transparent piece of plastic. A piece of paper, for example, bearing labelling indicia can be inserted into the recess, interposed between the base and the plastic, for external viewing. The labels 34a, 34b, 34c are preferably arranged under the connectors 12, 14a, 14b on the base 18. In the embodiment shown, the connectors 12, 14a, 14b need to be disconnected so that paper labels can be inserted into the receptacles. Each label 34a, 34b, 34c has a corresponding finger depression slot 36a, 36b, 36c that assists in their removal.

### Copper Connector

The copper connector 12 is preferably a right angled RJ45 modular jack 12 which is mounted for external connection with an RJ45 plug whose electric contacts are coupled to a plurality of twisted pairs of insulated conductors of the first data cable (not shown). Alternatively, the outlet box 10 includes any other jack 12 couplable to the mounting 47.

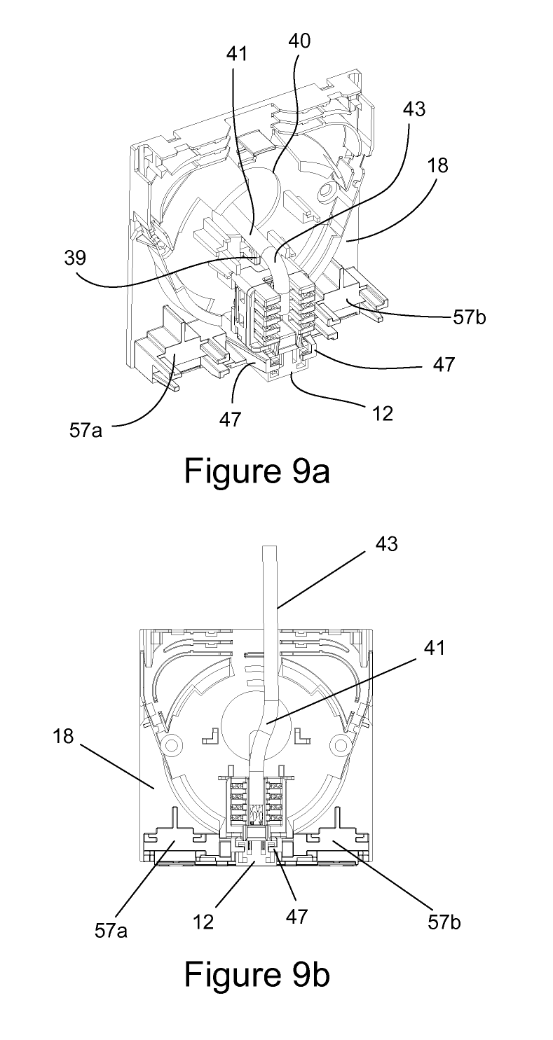

As particularly shown in FIG. 9a, the base 18 defines an access aperture 40 shaped to receive an end 41 of the second data cable 43 from a wall cavity (not shown) via the wall box 19. The aperture 40 is preferably 25 mm in diameter. The end 41 of the second data cable 43 enters the base 18 through the aperture 40 and connects to the copper connector 12 in a standard manner. That is, where the insulated conductors of the second data cable 43 are connected to respective contacts of the copper connector 12. The base 18 includes a cable tie down point 39 so that a neck of the second data cable 43 can be secured to the base 18. Alternatively, break out pieces 45a, 45b of the base can be removed during installation and the end 41 of the second data cable 43 can enter the base 18 in the manner shown in FIG. 9b for connection to the copper connector 12.

The copper connector 12 is mounted to the base by a keystone mounting 47 in the manner shown in FIGS. 5 to 8. The keystone mounting 47 is located centrally on the inner side 28 of the base 18 adjacent the access aperture 40 so that a socket of the copper connector 12 is externally accessible from a bottom side of the housing 16. The location of the mounting 47 enables the second data cable 43 to take the most direct route from the outlet box 10 to the wall cavity through the large central hole 40 in the base plate 18.

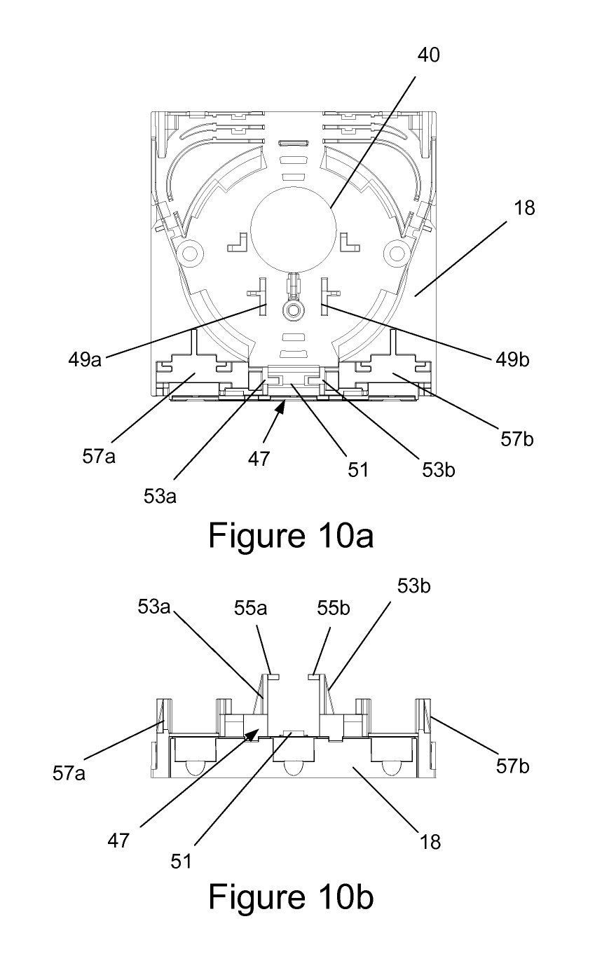

As particularly shown in FIGS. 10a and 10b, the keystone mounting 47 includes spaced apart inner mounts 49a, 49b and a peripheral mount 51 to support the connector 12 over the base 18. The spaced apart inner mounts 49a, 49b include recesses that are shaped to at least partially receive, and seat therein, respective corners of the copper connector 12. The inner mounts 49a, 49b thereby inhibit movement of the copper connector 12 towards the aperture 40 and inhibit side to side movement of the copper connector 12. The keystone mounting 47 also includes spaced apart brackets 53a, 53b that extend outwardly from the base 18 so as to at least partially bear against lateral sections of the copper connector 12 when arranged therebetween. The brackets 53a, 53b include opposed lugs 55a, 55b extending from respective ends thereof over a common side of the copper connector 12. The brackets 53a, 53b resiliently bear against lateral sections of the copper connector 12 to inhibit side to side movement of the connector 12. The brackets 53a, 53b also resiliently bear against the common side of the copper connector 12 to force it against the peripheral mount 51. The combined action of the inner mounts 49a, 49b; the peripheral mount 51; and the brackets 53a, 53b securely fasten the copper connector 12 to the base 18.

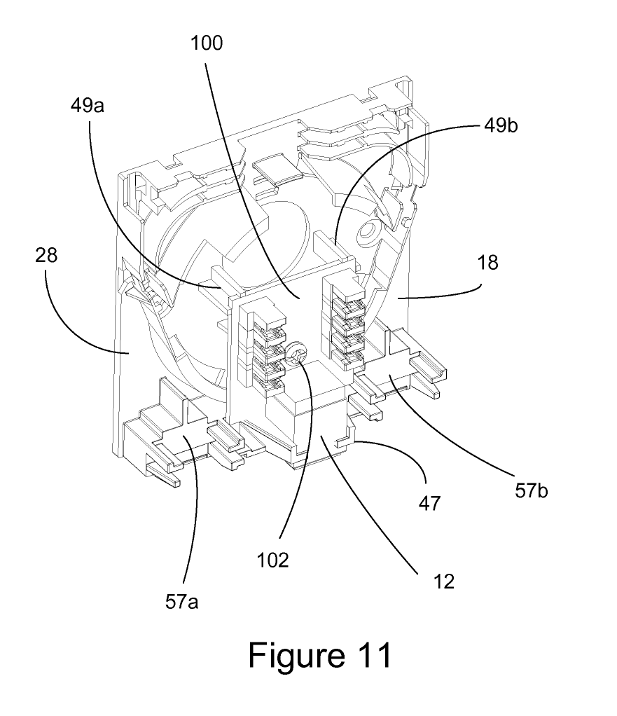

The outlet box 10 shown in FIG. 11, includes a tone test copper outlet circuit 100 coupled to the copper connector 12. The tone test copper outlet circuit 100 allows a telephone company to test the status of a telecommunications line by sending a signal down the line to the connector 12 and observing the response from the tone test copper outlet circuit 100. Advantageously, the tone test copper outlet circuit 100 reduces the amount of call outs to inspect outlet boxes 10 by allowing line assessment to be made from the service provider's end. The tone test copper outlet circuit 100 is secured in place by way of a fastener 102, such as a screw. The inner mounts 49a, 49b include recessed sections shaped to receive respective end corners of the printed circuit board 104 of the tone test copper outlet circuit 100.

### Optical Fibre Connectors

As particularly shown in FIGS. 10a and 10b, the outlet box 10 includes slip in mountings 57a, 57b for fastening the optic fibre connectors 14a, 14b to the base 18 for external connection to optical fibres (not shown). The mountings 57a, 57b are adapted to inhibit movement of the optic fibre connectors 14a, 14b with respect to the base 18.

The optical fibre connectors 14a, 14b are SC couplers 14a, 14b arranged for external connection to optical fibres (not shown) in a standard manner. Each SC coupler 14a, 14b is adapted to mate with two SC connectors (not shown) to form an optic connection therebetween. Alternatively, the optical fibre connectors 14a, 14b are LC couplers 14a, 14b arranged for external connection to optical fibres (not shown) in a standard manner. Each LC coupler 14a, 14b is adapted to mate with two LC connectors (not shown) to form an optic connection therebetween. The LC couplers 14a, 14b have twice the density of the SC couplers 14a, 14b. In either case, the mountings 57a, 57b of the base 18 remain the same. The outlet box 10 can thereby be configured to include any suitable arrangement of SC and LC couplers 14a, 14b supported by the mountings 57a, 57b to meet the requirements of a particular telecommunications system.

### Optical Fibre Management

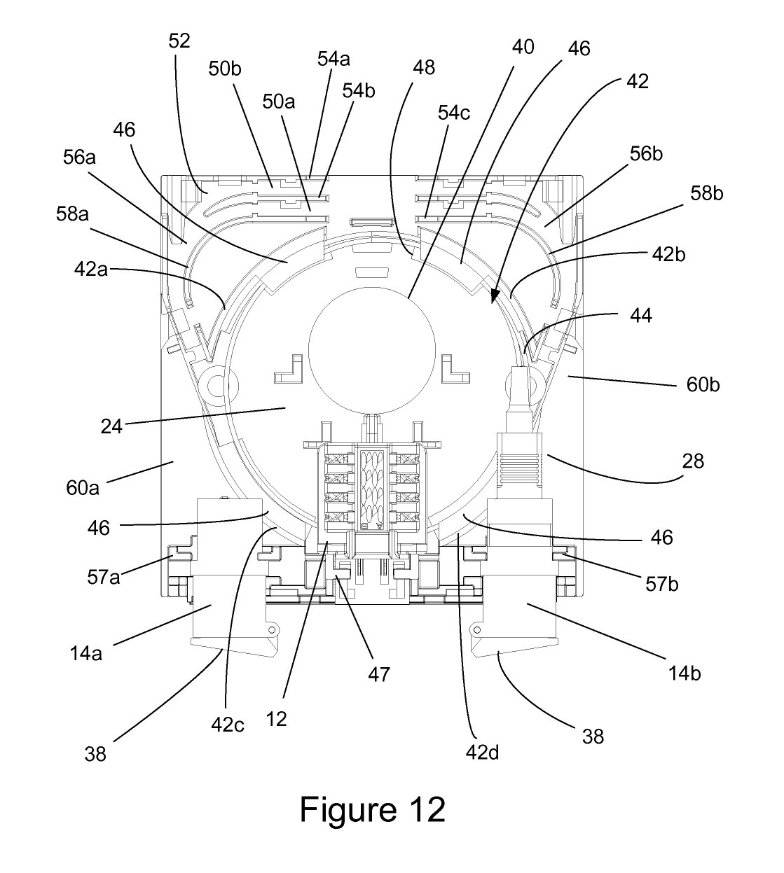

As particularly shown in FIG. 12, the inner side 28 of the base 18 manages the optical fibre transmission lines in such a fashion that a variety of termination and cabling methods are possible. The base 18 includes a cable management channel 42 for receiving and retaining optical fibres 44 in a generally circular arrangement around the data cable access aperture 40. As particularly shown in FIGS. 5 to 7, the cable management channel 42 is defined by four arced walls 42a, 42b, 42c, 42d that extend, around the data cable access aperture 40, outwardly from the inner side 28 of the base 18. The radius of the cable management channel 42 accommodates the use of standard bend radius optical fibre.

In use, an end 44 of an optical fibre can be received within the cable management channel 42 through one or more access apertures 48 defined in the base 18. The access apertures 48 permit optical fibres to be received from a wall cavity, via the wall box 19, and into cable management channel 42. In the arrangement shown in FIG. 11, an incoming optical fibre 44 is coupled to a field terminable connector 14b. The end 44 of an optical fibre is arranged in the cable manager 42 in the manner shown in FIG. 11 where it is coiled around the inside of the cable management channel 42. The internal spool for the end 44 is tapered outwards as it approaches the base 18 which causes the end 44 being spooled to sit toward the bottom of the channel 42 rather than the top. The natural spring of the cable 44 makes it group towards the inner side 28 of the base 18 as it is spooled. Further, the natural spring in the optical fibre 44 makes the fibre 44 expand radially outwards to bear against the inner peripheral side of the walls 42a, 42b, 42c, 42d of the cable management channel 42.

Each arced wall 42a, 42b, 42c, 42 of the cable management channel 42 includes a capping 46 extending radially inward over the inner side 28 of the base 18 towards the access aperture 40. The capping 46 defines the limit to which the coiled end 44 can expand away from the inner side 28 of the base 18. In the above described arrangement, optical fibres 44 are contained in the cable management channel 42 by the shape of the channel 42 and the natural resilience of the optical fibre 44.

The following steps are performed to interconnect the end 44 of optical fibre received from the wall cavity via the wall box 19 with the field terminable SC coupler 14b:
a. Receiving the end 44 of optical fibre through an access aperture 48 in the cable management channel 42;
b. Spooling the end 44 of the optical fibre around the cable management channel 42 in the above-described manner whereby the internal spool is tapered outwards as it approaches the base 18 which causes the end 44 of optical fibre to sit towards the bottom of the management rather than the top; and
c. Terminating the end 44 of the optical fibre with the field terminable SC coupler 14b.

The above-described steps are preferably performed before installation of the copper connector 12.

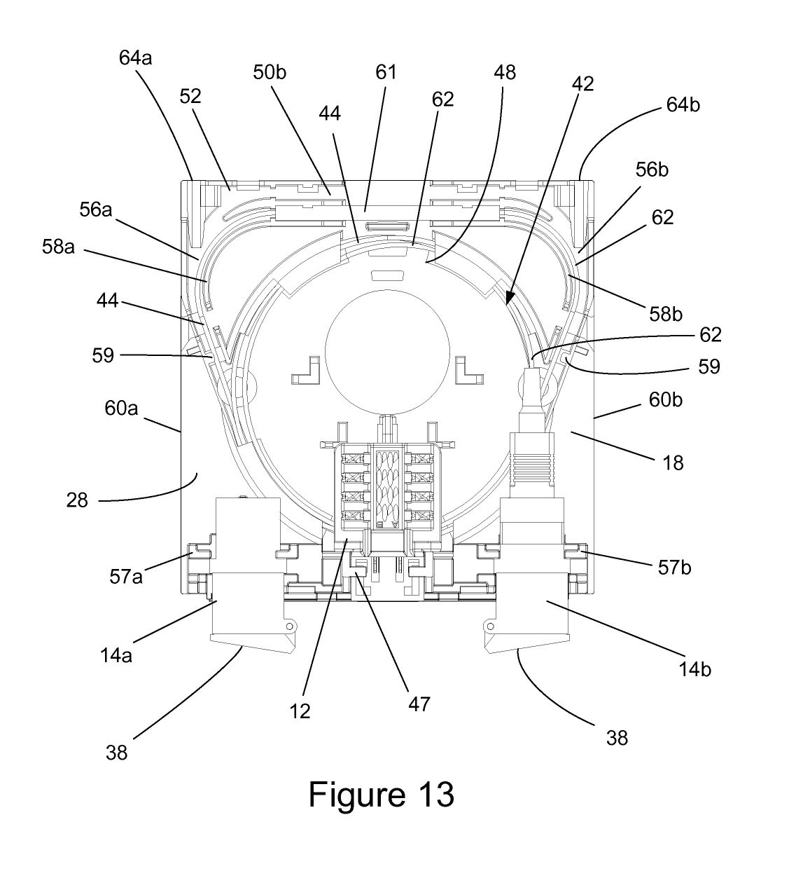

Analogous steps are performed for interconnecting an end (not shown) of another optical fibre received from the wall cavity via the wall box 19 with the other field terminable SC coupler 14a. However, the end of optical fibre is coiled in an opposite direction to that of the end 44. Further, analogous steps are performed for interconnecting ends of optical fibres received from the wall cavity via the wall box with other types of optical connectors.

Where a field terminable connector 14a, 14b is not desirable, a fusion splice 61 may be used to connect the incoming optical fibre 44 from the wall cavity with the pre-terminated pigtail 62 in the manner shown in FIG. 13. To facilitate this, the base 18 includes two fusion splice cable management channels 50a, 50b for receiving and retaining fusion splices 61 and corresponding end sections of optical fibres. The channels 50a, 50b extend, in parallel, in the width wise direction “W” along the top end 52 of the inner side 28 of the base 18. The channels 50a, 50b are defined by walls 54a, 54b, 54c that project outwardly away from the inner side 28 of the base 18. The fusion splice cable management channels 50a, 50b are each of suitable depth to accommodate two fusion splices 61.

Opposite ends of the fusion splice channels 50a, 50b open into bridging channels 56a, 56b, which, in turn, each open into the cable management channel 42. The bridging channels are defined by curved walls 58a, 58b which guide optical fibres from the top end 52 of the base 18, round respective lateral sides 60a, 60b of the base 18, and into the cable management channel 42.

With reference to FIG. 13, the following steps can be performed to interconnect an SC coupler 14b, for example, having a pig tail 62 with an end 44 of an optical fibre received from an access aperture 48:
a. Spooling the pigtail 62 of the SC coupler 14b around the cable management channel 42 in the above described manner whereby the internal spool is tapered outwards as it approaches the base 18 which causes the end 62 of optical fibre to sit towards the bottom of the management channel 42 rather than the top;
b. Directing the pigtail 62 into a corresponding bridging channel 56b and finally into an end of a corresponding fusion splice channel 50a;
c. Receiving the end 44 of the external optical fibre cable via the wall box 19 through an access aperture 48 into the cable management channel 42;
d. Spooling the end 44 of the cable around the cable management channel 42 in an opposite direction to that of the pigtail 62 in the above-described manner;
e. Directing the end 44 of the optical fibre into a corresponding bridging channel 56a and finally into the opposite end of the same fusion splice channel 50a; and
f. Effecting a fusion splice between the pigtail 62 and the end 44 of the external optical fibre with the fusion splice 61 seated in the channel 50a.

The fusion splice 61 joins the pigtail 62 to the end 44 of the external optical fibre. The fusion splice fuses the two fibers together in such a way that light passing through the fibers is not scattered or reflected back by the splice, and so that the splice and the region surrounding it are almost as strong as the virgin fiber itself. The source of heat is usually an electric arc, but can also be a tungsten filament through which current is passed. The following steps are necessary to splice optical fiber:
a. Stripping off the coatings of the two fibers to be spliced together;
b. Cleaning the fibers;
c. Cleaving each fiber so that its endface is perfectly flat and perpendicular to the axis of the fiber;
d. Aligning the two endfaces of the fibers;
e. Fusing the two fibers together;
f. Protecting the bare fiber area either by recoating or with a splice protector; and
g. Proof testing to ensure that the splice is strong enough to survive handling, packaging and extended use.

Analogous steps are performed for interconnecting the pig tail (not shown) of another SC coupler 14a with an end (not shown) of another optical fibre received from the wall cavity via the wall box. However, the pig tail is coiled in an opposite direction to that of the pigtail 62. Further, analogous steps are performed for interconnecting ends of optical fibres received from the wall cavity via the wall box with other types of optical connectors.

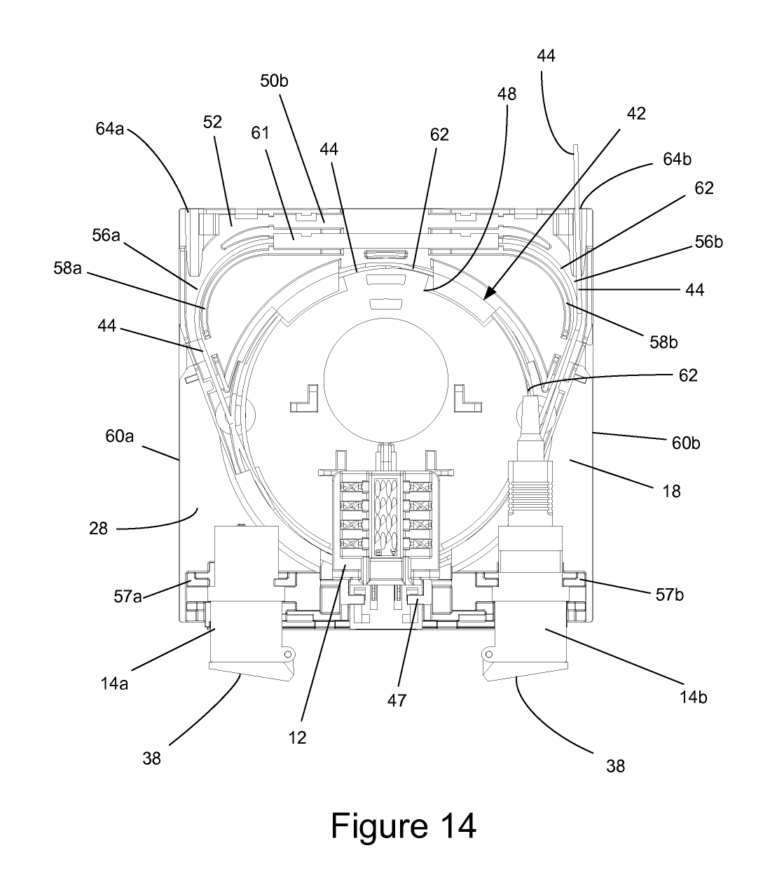

As above described, the end section 44 of the external optical fibre may enter the base 18 from the wall cavity via the type 86 wall box 19. Alternatively, the external optical fibre cable may be laid down the surface of the wall and enter the base 18 via breakout pieces 64a, 64b at the top end 52 of the base 18 in the manner shown in FIG. 14. In this arrangement, the following steps can be performed to interconnect an SC coupler 14a, for example, with the end 62 of optical fibre received:
a. Spooling the pigtail 62 of the SC coupler 14b around the cable management channel 42 in the above described manner whereby the internal spool is tapered outwards as it approaches the base 18 which causes the end 62 of optical fibre to sit towards the bottom of the management channel 42 rather than the top;
b. Directing the pigtail 62 into a corresponding bridging channel 56b and finally into an end of one of the fusion splice channels 50a;
c. Receiving the end 44 of the external optical fibre cable running down the surface of the wall through the breakout piece 64b into the bridging channel 56b and into the cable management channel 42;
d. Spooling the end 44 of the cable around the cable management channel 42 in an opposite direction to that of the pigtail 62 in the described manner;
e. Directing the end 44 of the optical fibre into a corresponding bridging channel 56a and finally into an opposite end of the same fusion splice channel 50a;
f. Effecting a fusion splice between the pigtail 62 and the end 44 of the external optical fibre using fusion splice 61.

As particularly shown in FIG. 7, both of the above described connection methods have optical fibre tie down points 66 and fibre retention tabs 59 to eliminate load on the fibre core. From this point the sheath of the incoming fibre can be stripped off to the buffer level and this can then be managed in the channel 42 and terminated in a variety of fashions.

The outlet box 10 is designed to the type 86 format allowing it to be installed over a preinstalled type 86 wall box 19.

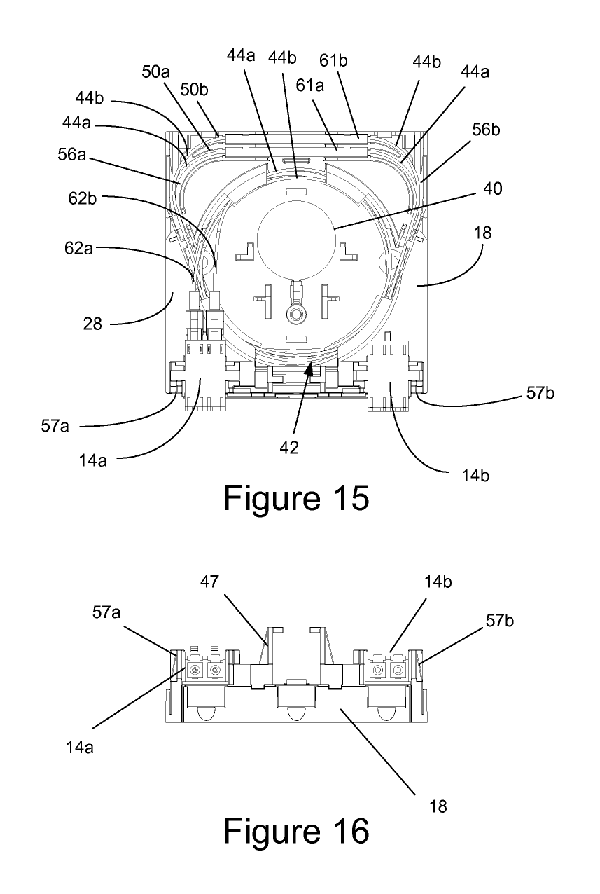

With reference to FIGS. 15 and 16, the following steps can be performed to interconnect an LC coupler 14a, for example, having a pig tails 62a, 62b with respective ends 44a, 44b of optical fibres received from access apertures 48:
a. Spooling the pigtails 62a, 62b of the LC coupler 14a around the cable management channel 42 in the above described manner whereby the internal spool is tapered outwards as it approaches the base 18 which causes the ends 62a, 62b of the optical fibres to sit towards the bottom of the management channel 42 rather than the top;
b. Directing the pigtails 62a, 62b into a corresponding bridging channel 56a and finally into respective fusion splice channel 50a, 50b;
c. Receiving ends 44a, 44b of external optical fibre cables via the wall box 19 through an access aperture 48 into the cable management channel 42;
d. Spooling the ends 44a, 44b of the cables around the cable management channel 42 in an opposite direction to that of the pigtails 62a, 62b in the above-described manner;
e. Directing the ends 44a, 44b of the optical fibres into a corresponding bridging channel 56b and finally into respective fusion splice channels 50a, 50b; and
f. Effecting a fusion splices between the pigtail 62a, 62b and the end 44a 44b of the external optical fibres with the fusion splices 61a, 61b seated in the channels 50a, 50b.

Analogous steps are performed for interconnecting the pig tails (not shown) of another LC coupler 14b with an end (not shown) of another optical fibre received from the wall cavity via the wall box. However, the pig tails are coiled in an opposite direction to that of the pigtails 62a, 62b. Further, analogous steps are performed for interconnecting ends of optical fibres received from the wall cavity via the wall box with other types of optical connectors.

In an alternative embodiment, the two fusion splices 61a, 61b are located in the same fusion splice channel 50a.

As above described, the end sections 44a, 44b of the external optical fibres may enter the base 18 from the wall cavity via the type 86 wall box 19. Alternatively, the external optical fibre cables may be laid down the surface of the wall and enter the base 18 via breakout pieces 64a, 64b at the top end 52 of the base 18 in the manner shown in FIG. 13.

The mountings will also allow for slim and large flange versions of fibre couplers 14a, 14b. A combination of fibre and copper connectors 14a, 14b, 12 may be used at the same time if required. Break out areas 64a, 64b of the cover allow for any of these combinations without leaving an orifice open. The cover 20 provides sufficient clearance from the topology of the landscape of components coupled to the base so that a suitable shutter may be fitted to an SC coupler 14a, 14b.

The inclusion of two separate fibre connections 14a, 14b and/or the ability to house two duplex LC connectors 14a, 14b will allow two different carriers to be connected to the one outlet box 10. Advantageously, this provides competitive market opportunities.

All fibre adaptors 14a, 14b are retained in the same fashion with adaptors 14a, 14b sliding into position with or without connector inserted. The adaptors 14a, 14b are preferably held in place by rib features of the cover 20.

While we have shown and described specific embodiments of the present invention, further modifications and improvements will occur to those skilled in the art. We desire it to be understood, therefore, that this invention is not limited to the particular forms shown and we intend in the append claims to cover all modifications that do not depart from the spirit and scope of this invention.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge in Australia.

### List of Parts

10 Telecommunications outlet box
12 Copper connector
14a, 14b Optical fibre connector
16 Housing
18 Base
19 Wall box
20 Cover
22 Outer side of base
24 Screw
26a, 26b Aperture for screw
28 Inner side of the base
29 Lugs
30 Clip
32 Common bottom side of the box
34a, 34b, 34c Label
36a, 36b, 36c Finger depression slot
38 Shutter
39 Cable tie down point
40 Data cable access aperture
41 End of second data cable
42 Cable management channel
42a, 42b, 42c, 42d Walls of cable management channel
43 Second data cable
44 End of optical fibre
45a, 45b Breakout piece
46 Capping of wall of cable management channel
47 Mounting for copper connector
48 Optical fibre access aperture
49a, 49b Inner mount
50a, 50b Fusion splice channel
51 Peripheral mount
52 Top end of base
53a, 53b Bracket
54a, 54b, 54c Wall of fusion splice channel
55a, 55b Lug
56a, 56b Bridging channel
57a, 57b Mounting for optical fibre connector
58a, 58b Wall of bridging channel
59 Fibre retention tab
60a, 60b Lateral side of base
61, 61a, 61b Fusion splice
62 Pigtail of optical fibre connector
63a, 63b, 63c Breakout panel
64a, 64b Breakout piece
66 Optical Fibre tie down point

1. A telecommunications outlet box for effecting connections between telecommunications transmission lines in a telecommunications system, comprising:
(a) a mounting for a copper connector for effecting electric connections between a plurality of twisted pairs of insulated conductors of a first data cable and a plurality of corresponding twisted pairs of insulated conductors of a second data cable; and
(b) two mountings for two separate optical fibre connectors for effecting optic connections between optical fibres, wherein the mounting for the copper connector and the mountings for the optical fibre connectors are respectively selectively couplable to copper and optical fibre connectors to configure the box for use in the telecommunications system.

2. The outlet box claimed in claim 1, including a housing having a base couplable to a wall box seated in a wall cavity of a work station area, and a cover couplable to the base.

3. The outlet box claimed in claim 2, wherein the mounting for the copper connector and the mountings for the optical fibre connectors are arranged so that copper and optical fibre connectors coupled thereto are accessible for external connection.

4. The outlet box claimed in claim 2, wherein the mounting for the copper connector and the mountings for the optical fibre connectors are arranged so that copper and optical fibre connectors coupled thereto are accessible for external connection from a common side of the outlet box.

5. The outlet box claimed in claim 4, wherein the common side of the box is a bottom side of the box that faces a floor or ground surface when the box is coupled to the wall box.

6. The outlet box claimed in claim 2, wherein the mounting for the copper outlet is arranged between the mountings for the optical fibre outlets.

7. The outlet box claimed in claim 2, wherein the base defines an access aperture for receiving an end of the second data cable via the wall box.

8. The outlet box claimed in claim 1, wherein mounting for the copper connector is a keystone mounting for an RJ45 connector.

9. The outlet box claimed in claim 2, including a cable management channel for receiving and retaining optical fibres.

10. The outlet box claimed in claim 9, wherein the cable management channel is generally cylindrical so as to retain the optical fibres in a generally circular arrangement.

11. The outlet box claimed in claim 10, wherein the radius of the cable management channel is equal to or greater than the bend radius of the optical fibres.

12. The outlet box claimed in claim 9, wherein the cable management channel includes an access aperture for receiving optical fibres from the wall box.

13. The outlet box claimed in claim 9, including two fusion splice channel cable management channels for receiving and retaining fusion splices and corresponding end sections of optical fibres.

14. The outlet box claimed in claim 13, wherein the fusion splice cable management channels open into said cable management channel.

15. The outlet box claimed in claim 13, wherein the fusion splice cable management channels are each of suitable depth to accommodate two fusion splices.

16. The outlet box claimed in claim 2, wherein the wall box is a type 86 wall box.

17. The outlet box claimed in claim 1, wherein the housing inhibits ingress of contaminants into the box.

18. The outlet box claimed in claim 1, including predetermined areas for bearing indicia labelling the copper connector and the optical fibre connectors.

19. The outlet box claimed in claim 1, wherein the optical fibre connectors are SC couplers.

20. The outlet box claimed in claim 1, wherein the optical fibre connectors are LC couplers.

21. A method for installing the outlet box claimed in claim 1, comprising the steps of:
(a) securing a copper connector to the copper connector mounting; and
(b) connecting the insulated conductors of the second data cable to corresponding contacts of the copper connector.

22. A method for installing the outlet box claimed in claim 11, comprising the steps of:
(a) securing a field terminable optical fibre connector to one of the optical fibre mountings; and
(b) spooling optical fibre of the field terminable optical fibre connector around a cable management channel of the outlet box in a conical manner so that the internal spool is tapered outwards as it approaches the base causing ends of the optical fibre to sit towards a bottom end of the management channel.

23. A method for installing the outlet box claimed in claim 13, comprising the steps of:
(a) securing an optical fibre connector to one of the optical fibre connector mountings;
(b) spooling a pigtail of said one of said optical fibre connectors around the generally circular cable management channel in a conical manner so that the internal spool is tapered outwards as it approaches the base causing ends of the pigtail to sit towards a bottom end of the management channel;
(c) directing an end of the pigtail into a corresponding fusion splice channel;
(d) receiving an end of an optical fibre through an access aperture in the cable management channel;
(e) spooling the end of the optical fibre, in an opposite direction to the pigtail, in a conical manner so that the internal spool is tapered outwards as it approaches the base causing ends of the optical fibre to sit towards a bottom end of the management channel;
(f) directing an end of the end of optical fibre into another end of the fusion splice channel; and
(g) fusion splicing the end of the pigtail with the end of said end of optical fibre.

24. A method for installing the outlet box claimed in claim 13, comprising the steps of:
(a) securing an optical fibre connector to one of the optical fibre connector mountings;
(b) spooling a pigtail of said one of said optical fibre connectors around the generally circular cable management channel in a conical manner so that the internal spool is tapered outwards as it approaches the base causing ends of the pigtail to sit towards a bottom end of the management channel;
(c) directing an end of the pigtail into a corresponding fusion splice channel;
(d) receiving an end of an optical fibre through a break away panel in the outlet box;
(e) spooling the end of the optical fibre, in an opposite direction to the pigtail, in a conical manner so that the internal spool is tapered outwards as it approaches the base causing ends of the optical fibre to sit towards a bottom end of the management channel;
(f) directing an end of the end of optical fibre into another end of the fusion splice channel; and
(g) fusion splicing the end of the pigtail with the end of said end of optical fibre.

25. The method claimed in claim 22, comprising the steps of securing a copper connector to the copper connector mounting; and connecting the insulated conductors of the second data cable to corresponding contacts of the copper connector.

26.-27. (canceled)
